(19) United States
(12) Patent Application Publication
(10) Pub. No.: US 2011/0025933 A1
(43) Pub. Date: Feb. 3, 2011

(54) TELEVISION WITH ANTIMICROBIAL COATING

(75) Inventors: John Schindler, Ladera Ranch, CA (US); Pat William Price, Rhome Ranch, TX (US)

Correspondence Address: Documents and Design, LLC, 206 North Derby Lane, North Sioux City, SD, 57049, US

(73) Assignee: VIZIO INC., Irvine, CA (US)

(21) Appl. No.: 12/512,275

(22) Filed: Jul. 30, 2009

(51) Int. Cl. H04N 5/64

(52) U.S. Cl. 348/843; 348/E05.128

(57) ABSTRACT

An application for a television that minimizes the transference of pathogens includes a television with a display panel and bezel plus an antimicrobial coating that is deposited on various external surfaces of the television such as the display panel and bezel, thereby reducing g the transfer of active pathogens from one user of the television to another user.

### FIELD OF THE INVENTION

This invention relates to the field of display devices and more particularly to a television having an antimicrobial coating on some or all of its external surfaces.

### BACKGROUND OF THE INVENTION

There are many ways in which infectious pathogens such as bacteria or germs spread from one person to another in a family or public place. Most residences have televisions, audio players, and other devices used in the residence by more than one occupant. Children often carry infectious agents from school where the agent is acquired from other children who may have been sick. Typically all members of a family will handle or touch televisions, especially portable televisions. In such, the television becomes a point of contact and enables the transfer of germs, bacteria, and viruses.

What is needed is a television that reduces the opportunity for transferring germs, bacteria and viruses between users of the television.

### SUMMARY

The present minimizes the transference of pathogens between members of a family or group that utilize a television. The television has an antimicrobial coating on one or more external surfaces and the antimicrobial coating includes antimicrobial agents that reduce the transfer of active pathogens from one user of the television to another user.

In one embodiment, a television is disclosed including a display panel having an exterior surface; a bezel surrounding the display panel, the bezel also having an exterior surface; and a rear housing, the rear housing also having an exterior surface. An antimicrobial coating is applied to at least a portion of at least one of the exterior surfaces. The antimicrobial coating inhibits the growth of microorganisms on the portion of the at least one of the exterior surfaces to which it is applied.

In another embodiment method of manufacturing a television is disclosed including manufacturing the television including installing a display panel within a bezel and sealing the television with a rear housing portion and coating at least one external component of the television with an antimicrobial coating.

In another embodiment, a television is disclosed including a display panel that has an exterior surface; a bezel surrounding the display panel also having an exterior surface; and a rear housing, the rear housing also having an exterior surface. A first antimicrobial coating is applied to a viewing surface of the display panel and a second antimicrobial coating is applied to an external surface of the bezel. The antimicrobial agents inhibit the growth of microorganisms on the viewing surface of the display panel and on the external surface of the bezel.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a television of the prior art.

FIG. 2 illustrates a television 6 of the present invention.

FIG. 3 illustrates a detail view of the coating on the television 6 of the present invention.

FIG. 4 illustrates a rear view of the television 6 of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. Throughout this description, the term “antimicrobial coating” refers to any material that acts to reduce germs, viruses, fungi, yeasts, microorganisms and/or bacteria, often referred to an anti-virucidal, anti-bacterial, and/or anti-germicidal coating.

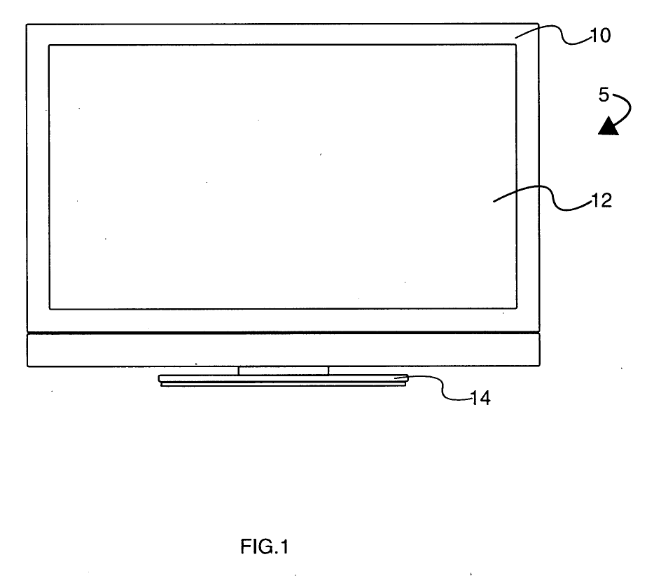

Referring to FIG. 1, a plan view of a television 5 with bezel 10 of the prior will be described. In such, the television 5 has a display panel 12 surrounded by a bezel 10. Often, such a television 5 is situated on a stand 14 or wall mounted. Often, users touch the television bezel, connection areas, switches and buttons and display. This often results in a transfer of pathogens from one user to another. In some embodiments, the display panel 12 is a touch-screen. In such embodiments, it is expected that several users touch the display panel 12 during use, thereby encouraging the transfer of pathogens from one user to the other users.

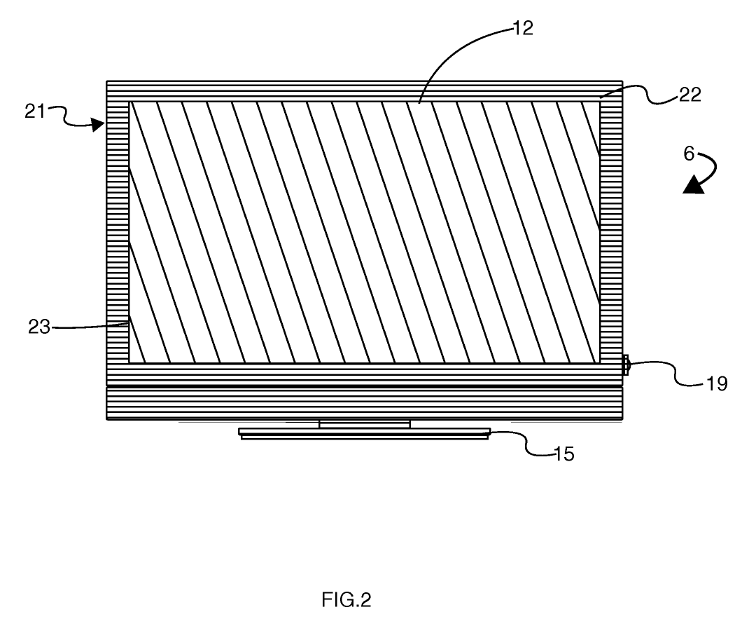

Referring to FIG. 2, a plan view of a television 6 of the present invention will be described. In this, some or all external components of the television 6 are coated with an antimicrobial coating. The bezel 22, switches/buttons 19, stand 15 and/or other parts (not shown) are coated with the antimicrobial coating 21, which prevents the spread of germs, viruses, yeasts, fungi and other microorganisms by inhibiting their reproduction and/or reducing their life span. In some embodiments, the display panel 12 is coated with an antimicrobial coating 23. It is anticipated that in some embodiments, a different antimicrobial coating 23 is applied to the display panel (different from the coating 21).In this, the antimicrobial coating 23 does not restrict visibility (must be substantially clear) of an image on the display panel 12 while the antimicrobial coating 23 includes materials that make it less transparent.

When a user contacts the television 6, there is a transfer of various microorganisms from the user to the television 6. However, the antimicrobial coating 21/23 of the present invention reduces the number of microorganisms on the surface of the television 6 and, thus, prevents the further transfer of the germs to a subsequent user. The microorganisms are reduced by reducing their life span or preventing multiplication (cell division).

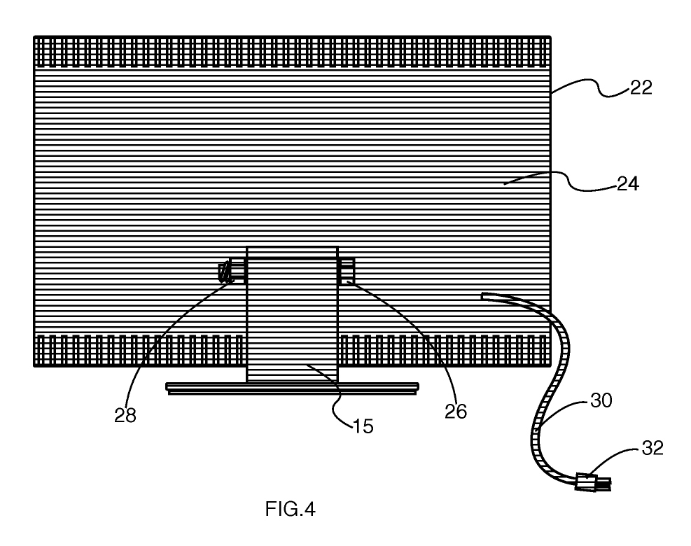

An antimicrobial coating 21 is applied to various surfaces of the television 6, including the bezel 22, the stand 15, the power cable 30 (see FIG. 4), the power plug 32 (see FIG. 4), the back surfaces 24 (see FIG. 4), mechanical parts 26/28 (see FIG. 4), switches and buttons (not shown), etc. The same or a different antimicrobial coating 23 is applied the viewing area of the display panel 12.

The antimicrobial coatings 21/23 generally comprise a number of different chemicals or additives (agents) commonly used as disinfectants as known in the current art. For example, one embodiment of the present invention the antimicrobial coatings 21/23 include a chlorine dioxide-generating formulation (agent) containing chlorine dioxide, sodium chlorate surfactant, and an acid moiety as the antimicrobial agent. A commercially available example of such a time-release chlorine dioxide formulation described in U.S. Pat. Nos. 5,631,300; 5,639,295; 5,650,446; and 5,668,185. Other examples of materials used to generate chlorine dioxide, for instance, are disclosed in U.S. Pat. Nos. 4,681,739; 4,689,169; 5,126,070; 5,227,168; and 5,407,685. The above patents are herein incorporated by reference.

In another embodiment of the present invention, the antimicrobial coatings 21/23 includes silver ions as the antimicrobial agent. For example, a silver-zeolite complex is incorporated in the coatings 21/23 to provide controlled release of the antimicrobial agent. One commercially available example of such an agent is used in HEALTH SHIELD under the name GUARDTEX. Other suitable silver-containing microbial agents are disclosed in Japanese patent No. JP 10/259325. In addition to silver-zeolites, other metal-containing inorganic additives are anticipated in the present invention. Examples of such additives include, but are not limited to, copper, zinc, mercury, antimony, lead, bismuth, cadmium, chromium, thallium, or other various additives, such as disclosed in Japanese patent No. JP 1257124 A and U.S. Pat. No. 5,011,602 to Totani, et al., which are herein incorporated by reference. In some embodiments, the activity of the additive is amplified by secondary materials, such as described in U.S. Pat. No. 5,900,383 to Davis, et al., which is herein incorporated by reference.

In another embodiment of the present invention, the antimicrobial coatings 21/23 include calcium hypochlorite particles as the antimicrobial agent. An example of a commercially available form of calcium hypochlorite particles suitable for use in the present invention is ALDRICH-brand #24-415-5. In some embodiments, the antimicrobial agent is polymerized or encapsulated to enhance the ability to control the amount of antimicrobial agent released over an extended period of time.

Other antimicrobial agents are anticipated. Examples of such antimicrobial agents include, but are not limited to, quaternary amines, halogens, chlorine dioxide, silver ions, and combinations thereof.

Another antimicrobial agent anticipated is disclosed in U.S. Pat. No. 5,837,274 to Shick, et al., which is herein incorporated by reference. Other antimicrobial agents are anticipated for use in the coatings 21/23, for example, liquid quats, such as alkyl aryl benzalkonium chloride, or other materials such as aqueous or resinous triclosan. One known example of such an antimicrobial agent is a resinous form of triclosan distributed by The Microban Products Company of Huntersville, N.C., and sold under the name “MICROBAN”, which is disclosed in U.S. Pat. No. 4,533,435 and U.S. Pat. No. 5,919,554, which are herein incorporated by reference.

Other examples of suitable antimicrobial agents are carboxylic acids as disclosed in U.S. Pat. No. 4,828,912 to Hossain, et al., which is herein incorporated by reference. Also those disclosed in U.S. Pat. No. 4,888,175 which is herein incorporated by reference.

The list of antimicrobial agents also includes chlorohexidine gluconate; parachlorometaxylenol (PCMX); benzylthoneium chloride; chitosan, such as chitosan pyrrolidone carboxylate; and those described in U.S. Pat. No. 5,871,763, U.S. Pat. No. 5,334,388, and U.S. Pat. No. 5,686,089, which are herein incorporated by reference.

It is anticipated that the coatings antimocrobial 21/23 on various components, surfaces and/or parts of the television 6 comprise a single antimicrobial agent or a combination of antimicrobial agents. For example, two or more of the above-identified antimicrobial agents are integrated into the coating 23 that is applied to the display panel 12 during or after manufacturing of the television 6, thereby providing protection for a broader range of microorganisms.

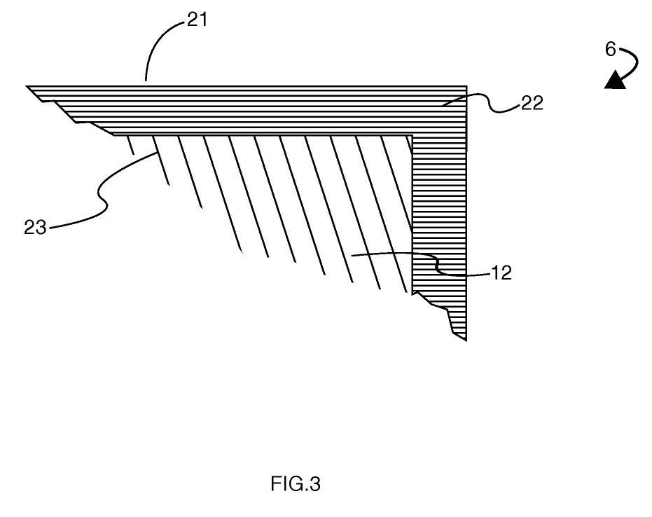

Referring to FIG. 3, a detail view of the coating on the television 6 of the present invention will be described. In this example, the bezel 22 is coated with one of the above described antimicrobial coatings 21 and the display panel 12 is coated with a second of the above described antimicrobial coatings 23. It is anticipated that any or all surfaces of the television 6 is coated with the antimicrobial coating 21/23. It is also anticipated that some surfaces are coated with a first antimicrobial coating 21 and other surfaces are coated with a second antimicrobial coating 23. For example, due to transparency requirements, the first antimicrobial coating 21 comprises compounds that are more effective but cannot be used on the display panel 12 because they reduce image clarity. In this example, the display panel is coated with a second antimicrobial coating 23 that is acceptable for viewing purposes, but, in some cases, is less effective in reducing the transfer of microorganisms.

Referring to FIG. 4, a rear view of the television 6 of the present invention will be described. In this example, various components of the television 6 are coated with the antimicrobial coating 21, including, but not limited to, the side of the bezel 22, the rear surface 24, the back of the stand 15, the hardware (nuts, bolts) used, for example, to hold the television 6 to the stand 15, the power cord 30 and the plug 32. It is anticipated that many other components (not visible) are also coated with the antimicrobial coating 21 such as power switches, push buttons, volume controls, associated cables (e.g., HDMI cable), antenna, etc.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A television comprising:
a display panel, the display panel having an exterior surface;
a bezel surrounding the display panel, the bezel having an exterior surface;
a rear housing, the rear housing having an exterior surface; and
an antimicrobial coating applied to at least a portion of at least one of the exterior surfaces, the antimicrobial coating includes one or more antimicrobial agents that inhibits the growth of microorganisms on the portion of the at least one of the exterior surfaces to which the antimicrobial coating is applied thereto.

2. The television of claim 1, wherein the one or more antimicrobial agents includes triclosan.

3. The television of claim 2, wherein the one or more antimicrobial agents includes a resinous form of triclosan.

4. The television of claim 1, wherein the one or more antimicrobial agents includes a carboxylic acid.

5. A television of claim 1, wherein a first antimicrobial agent is contained within a coating composition applied to the exterior surface of the display panel and a second antimicrobial agent is contained within a coating composition applied to the exterior surface of another component of the television.

6. A method of manufacturing a television, the method comprising:
manufacturing the television including installing a display panel within a bezel and sealing the television with a rear housing portion; and
coating at least one external surface of the television with an antimicrobial coating, the antimicrobial coating including one or more antimicrobial agents.

7. The method of claim 6, wherein the one or more antimicrobial agents include triclosan.

8. The method of claim 7, wherein the one or more antimicrobial agents include a resinous form of triclosan.

9. The method of claim 6, wherein the one or more antimicrobial agents include a carboxylic acid.

10. The method of claim 6, wherein the at least one external surface is selected from the group consisting an external surface of the bezel, an external surface of the rear housing portion, an external surface of a power cable, an external surface of a power plug, an external surface of a stand and an external surface of the display panel.

11. The method of claim 6, further comprising the step of coating a viewing surface of the display panel with a second antimicrobial coating, the second antimicrobial coating including one or more antimicrobial agents.

12. A television comprising:
a display panel, the display panel having an exterior surface;
a bezel surrounding the display panel, the bezel having an exterior surface;
a rear housing, the rear housing having an exterior surface; and
a first antimicrobial coating applied to a viewing surface of the display panel and a second antimicrobial coating applied to an external surface of the bezel, the antimicrobial coatings including at least one antimicrobial agent, the at least one antimicrobial agent inhibiting the growth of microorganisms on the viewing surface of the display panel and on the external surface of the bezel.

13. The television of claim 12, wherein the at least one antimicrobial agent include triclosan.

14. The television of claim 13, wherein the at least one antimicrobial agent include a resinous form of triclosan.

15. The television of claim 12, wherein the at least one antimicrobial agent include a carboxylic acid.

16. A television of claim 12, wherein the first antimicrobial coating comprises a same at least one antimicrobial agent as the second antimicrobial coating.

17. A television of claim 12, wherein the television further comprises a power cable and a power plug and the second antimicrobial coating is applied to an external surface of both the power cable and the power plug.

18. A television of claim 12, wherein the television further comprises a stand and the second antimicrobial coating is applied to an external surface of the stand.

19. A television of claim 12, wherein the television further comprises push buttons the second antimicrobial coating is applied to an external surface of the push buttons.
